(19) United States
(12) Patent Application Publication
(10) Pub. No.: US 2012/0166817 A1
(43) Pub. Date: Jun. 28, 2012

(54) Secured Data Display Method, Data Storage Device and Encryption Chip Card

(76) Inventors: Hsi-Chang Wu, Hsinchu City (TW); Pei-Wen Sun, Hsinchu County (TW); Yen-Tsai Huang, Hsinchu County (TW); Yu-Shiang Lu, Chiayi County (TW); Richard Lin, Hsinchu City (TW)

(21) Appl. No.: 13/046,771

(22) Filed: Mar. 14, 2011

(30) Foreign Application Priority Data
Dec. 23, 2010 (TW) 099145444

(51) Int. Cl. G06F 12/14

(52) U.S. Cl. 713/193

(57) ABSTRACT

The present invention discloses secured data display method capable of non-intrusively and non-destructively displaying secured data in a secured data storage device of an encryption system. The secured data display method includes steps of receiving and storing a secured data transmitted via a first encryption mechanism according to a first communication protocol, and receiving an output data transmitted by a data access device of the encryption system according to a second communication protocol. The secured data and the output data comprise a same content.

### BACKGROUND OF THE INVENTION

1. Field of the Invention

The present invention relates to a secured data display method, a secured data storage device and an encryption chip card, and more particularly, a secured data display method, a secured data storage device and an encryption chip card capable of non-intrusively and non-destructively displaying secured data.

2. Description of the Prior Art

Generally, current encryption systems on market include a data access device and a secured data storage device. The data access device is capable of transmitting a secured data to the secured data storage device for storage via a predefined encryption mechanism, and when a user intends to operate according to the stored secured data, it is necessary to first utilize the data access device or other data access devices with the same predefined encryption mechanism to decrypt the secured data, so as to proceed with subsequent operations. In other words, writing or reading the secured data are required to be executed via the predefined encryption mechanism, to prevent malicious third parties from modifying the secured data.

For example, please refer to FIG. 1, which is a schematic diagram of a conventional encryption chip card 10. As shown in FIG. 1, the encryption chip card 10 and a card reader 12 can be seen as an encryption system. The card reader 12 transmits a secured data EncData to an encryption chip 100 for storage via an encryption mechanism Enc, such that the user may utilize the encryption chip card 10 on the card reader 12 or other card readers with the same encryption mechanism Enc, to perform operations such as credit deduction, query, etc.

However, since encryption chip cards (or other secured data storage devices) usually do not have display functionalities, when the user intends to query a remaining credit, etc, of the encryption chip card, it is required to read the encryption chip card on predefined readers at certain predefined locations via a predefined encryption mechanism, in order to query an internal data of the encryption chip card, and thus lacking in convenience of usage. Moreover, general encryption systems are subject to regulations and limitations imposed by certifying institutions of encryption security, i.e. it is required to perform read or other operations on the secured data stored in the secured data storage device via predefined encryption mechanisms, and thus lacking in extensibility due to difficult integration with external components. Hence, it is necessary to improve over prior art techniques.

### SUMMARY OF THE INVENTION

Therefore, the primary objective of the present invention is to provide a secured data display method, secured data storage device and encryption chip card capable of non-intrusively and non-destructively displaying secured data.

The present invention discloses a secured data display method for a secured data storage device of an encryption system, capable of non-intrusively and non-destructively displaying secured data. The secured data display method comprises receiving and storing a secured data transmitted via a first encryption mechanism according to a first communication protocol; and receiving an output data transmitted by a data access device of the encryption system according to a second communication protocol; wherein the secured data and the output data contain a same content.

The present invention further discloses a secured data storage device capable of non-intrusively and non-destructively displaying secured data for an encryption system. The secured data storage device comprises an encryption unit for receiving and storing a secured data transmitted via a first encryption mechanism according to a first communication protocol; and an output unit, for receiving an output data transmitted by a data access device of the encryption system according to a second communication protocol; wherein the secured data and the output data contain a same content.

The present invention further discloses an encryption chip card, capable of non-intrusively and non-destructively displaying secured data in an encryption/decryption environment. The encryption chip card comprises an encryption chip, for receiving and storing a secured data transmitted via a first encryption mechanism according to a first communication protocol and an output chip, for receiving an output data transmitted by the reader according to a second communication protocol, wherein the secured data and the output data contain a same content.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional encryption chip card.

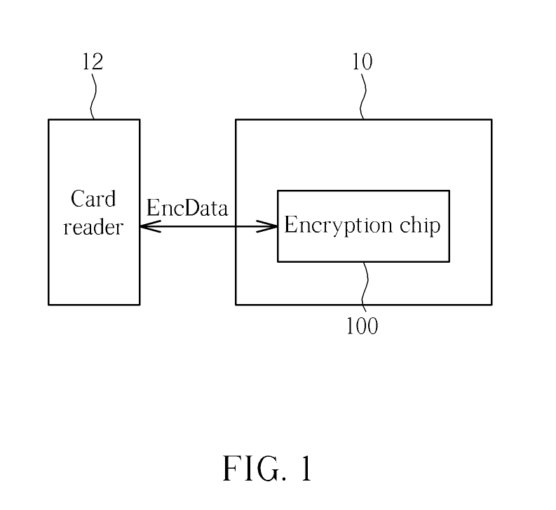

FIG. 2 is a schematic diagram of a secured data display process according to an embodiment of the present invention.

FIG. 3 is a schematic diagram of a secured data storage device according to an embodiment of the present invention.

### DETAILED DESCRIPTION

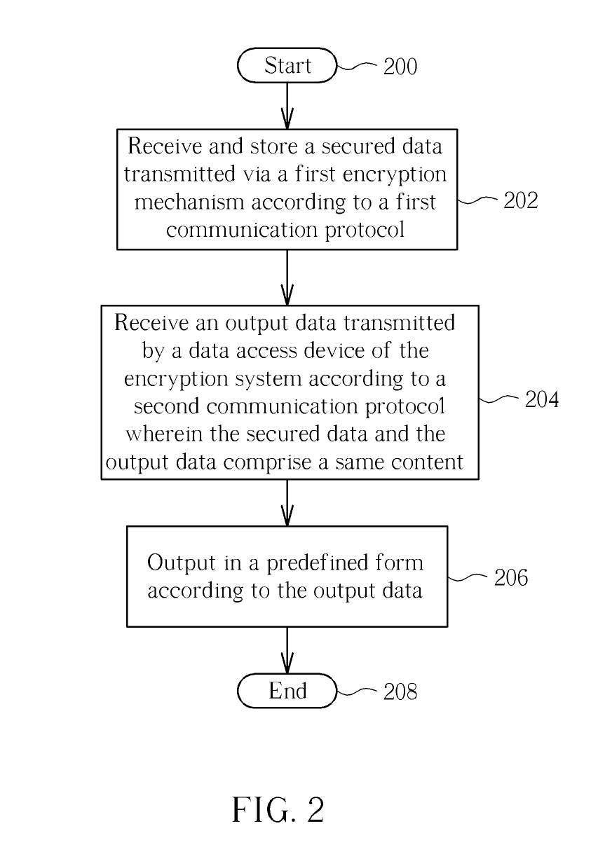

Please refer to FIG. 2, which is a schematic diagram of a secured data display process 20 according to an embodiment of the present invention. Generally, an encryption system usually includes a data access device and a secured data storage device, and the secured data display process 20 is utilized in the secured data storage device. The secured data display process 20 includes the following steps:

Step 200: Start.

Step 202: Receive and store a secured data transmitted via a first encryption mechanism according to a first communication protocol.

Step 204: Receive an output data transmitted by a data access device of the encryption system according to a second communication protocol; wherein the secured data and the output data comprise a same content.

Step 206: Output in a predefined form according to the output data.

Step 208: End.

According to the secured data display process 20, the secured data storage device receives and stores the secured data transmitted via the first encryption mechanism according to the first communication protocol, then receives the output data, which comprises the same content as the secured data, transmitted by the data access device according to the second communication protocol, then outputs in a predefined form (e.g. visual display or audio) according to the output data. The data access device transmits the output data to the secured data storage device according to the second communication protocol and not via the first encryption mechanism. Consequently, when integrating the secured data storage device with other components to extend functions unrelated to modification of the secured data, e.g. query or display the secured data, etc, since the secured data and the output data comprise the same content, the output data may be directly utilized to perform operations, without the first encryption mechanism, thus enabling non-intrusive and non-destructive operations such as displaying data, without involving the secured data.

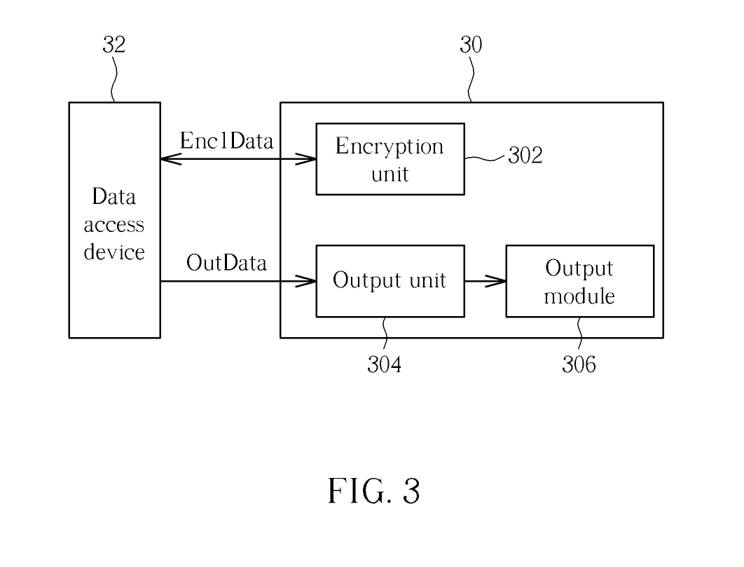

Specifically, please refer to FIG. 3, which is a schematic diagram of a secured data storage device 30 according to an embodiment of the present invention. The secured data storage device 30 and a data access device 32 can be seen as an encryption system. The secured data storage device 30 includes an encryption unit 302 and an output unit 304. The encryption unit 302 receives and stores a secured data Enc1Data transmitted via an encryption mechanism Enc1 according to a communication protocol Pro1. The output unit 304 receives an output data OutData transmitted by a data access device 32 according to a communication protocol Pro2, wherein the secured data Enc1Data and the output data OutData comprise a same content, e.g. remaining credits or other data. As a result, when displaying or performing query on the secured data Enc1Data or extending functionalities of the secured data storage device 30 unrelated to modification of the secured data Enc1Data, since the secured data Enc1Data and the output data OutData comprise the same content, the output data OutData may be directly utilized to perform operations without involving the encryption mechanism Enc1, thus making it possible to non-intrusively and non-destructively display data, without involving the secured data Enc1Data. In this way, operations may be performed according to the output data OutData, which comprise the same content as the secured data Enc1Data, without need for the encryption mechanism Enc1. Thus, apart from improving convenience of usage and extensibility of the secured data storage device 30, data security and integrity of the secured data Enc1Data stored in the output unit 304 may also be ensured.

In more detail, when the data access device 32 is performing a write operation on the encryption unit 302, the data access device 32 can transmit the secured data Enc1Data to the encryption unit 302 for storage via an encryption mechanism Enc1 according to the communication protocol Pro1, and since the content of the secured data Enc1Data is known, the data access device 32 may simultaneously transmit the output data OutData, which comprises the same content as the secured data Enc1Data, to the output unit 304 according to communication protocol Pro2. On the other hand, when the data access device 32 is performing a read operation on the encryption unit 302, since another reader which has previously written the secured data Enc1Data to the encryption unit 302 may not have simultaneously transmitted data comprising the same content to the output unit 304, the data access device 32 may read the secured data Enc1Data stored in the encryption unit 302 via an encryption mechanism Enc1 according to communication protocol Pro1; and since the content of the secured data Enc1Data is known, the data access device 32 may simultaneously transmit the output data OutData, which comprise a the same content as the secured data Enc1Data, to the output unit 304 according to communication protocol Pro2. In this way, the output data OutData and the secured data Enc1Data may be ensured to comprise the same content, facilitating subsequent operations.

Note that, the spirit of the present invention is to further transmit an output data which comprise a same content as the secured data to the secured data storage device for storage, without the original encryption mechanism applied for the secured data, thus the output data may be directly utilized for performing operations such as query, display, etc without involving the original encryption mechanism. Therefore it is possible to non-intrusively and non-destructively display data without involving the secured data, ensuring data integrity and security of the secured data. Those skilled in the art can make modifications or alterations accordingly and are not limited thereto. For instance, the secured data storage device 30 can further include a module for operations such as querying or displaying the secured data Enc1Data, or for extending functionalities of the secured data storage device 30 unrelated to modification of the secured data Enc1Data, to extend functions of the secured data storage device 30 while ensuring data integrity and security of the secured data Enc1Data.

Specifically, the secured data storage device 30 may further include an output module 306, for outputting in a predefined form according to the output data OutData, allowing the user to know the content of the output data OutData (i.e. the content of the secured data Enc1Data). For example, the output module 306 may be a liquid crystal display (LCD), a screen or an electronic paper or any device capable of outputting in a visual display form, to directly display the content of the output data OutData, or to indirectly indicate the content of the output data OutData through light or color patterns with predefined meanings; for another example, the output module 306 may be an audio speaker or any other device capable of outputting an audio form, to indirectly indicate the content of the output data OutData to the user through sounds with predefined meanings. The output module 306 may output in any predefined form, not limited to above-mentioned embodiment, so long as the user knows the content of the output data OutData. In this way, the user does not need to utilize predefined data access devices and the secured data storage device 30 at predefined locations communicating through the encryption mechanism Enc1, and is capable of non-intrusively and non-destructively querying the internal data of the secured data storage device 30 at any time (e.g. an encryption chip card capable of displaying remaining credit at any time), thus improving convenience of usage.

Moreover, to ensure secure transmission of the output data OutData from the data access device 32 to the output unit 304, the data access device 32 may further transmit via an encryption mechanism Enc2, for the output unit 304 to receive the output data OutData transmitted by the data access device 32 via the encryption mechanism Enc2 according to the communication protocol Pro2, so long as the encryption mechanism Enc2 differs from the encryption mechanism Enc1. Additionally, the communication protocol Pro1 and the communication protocol Pro2 may be contactless communication protocols, or contact-based communication protocols; and the communication protocol Pro1 and the communication protocol Pro2 may be a same communication protocol, or different communication protocols, so long as the data access device 32 is capable of transmitting the output data OutData with a same content to the output unit 304 without the encryption mechanism Enc1.

Furthermore, the secured data storage device 30 is preferred to be an encryption chip card, the data access device 32 preferred to be a reader, and the encryption unit 302 and the output unit 304 preferred to be an encryption chip and an output chip, but may also be any other encryption system not limited thereto, and any encryption system with predefined encryption mechanism capable of achieving above-mentioned related operations are within scope of the present invention.

In the prior art, an encryption chip card (or another secured data storage device) usually does not have a display function, thus it is necessary to utilize a predefined reader at a predefined location to communicate with the encryption chip card via a predefined encryption mechanism, in order to query internal data of the encryption chip card, therefore lacking in convenience of usage. Moreover, due to regulations and limitations imposed by certifying institutions of encryption security, conventional encryption chip cards lack extensibility due to difficult integration with external components. Comparatively, the present invention does not utilize the original encryption mechanism but further transmits the output data, which comprises a same content as the secured data, to the secured data storage device for storage, thus operations may be performed according to the output data without the original encryption mechanism applied for the secured data. In addition to ensuring data integrity and security, it is possible to improve extensibility of the secured data storage device, allowing non-intrusive and non-destructive query into the internal data of the secured data storage device at anytime, and thus improving convenience of usage.

In summary, the present invention does not utilize the original encryption mechanism but further transmits the output data, which comprises a same content as the secured data, to the secured data storage device for storage, thus ensuring data integrity and security, as well as convenience of usage and extensibility of the secured data storage device.

Those skilled in the art will readily observe that numerous modifications and alterations of the device and method may be made while retaining the teachings of the invention.

What is claimed is:

1. A secured data display method capable of non-intrusively and non-destructively displaying secured data in a secured data storage device of an encryption system, which comprises:
receiving and storing a secured data transmitted via a first encryption mechanism according to a first communication protocol; and
receiving an output data transmitted by a data access device of the encryption system according to a second communication protocol;
wherein the secured data and the output data comprise a same content.

2. The secured data display method of claim 1, wherein the step of receiving and storing the secured data transmitted via the first encryption mechanism according to the first communication protocol comprises:
receiving and storing the secured data transmitted by the data access device via the first encryption mechanism according to the first communication protocol.

3. The secured data display method of claim 1, wherein the data access device reads the secured data stored in the secured data storage device via the first encryption mechanism according to the first communication protocol, and then transmits the output data according to the second communication protocol.

4. The secured data display method of claim 1 further comprising outputting in a predefined form according to the output data.

5. The secured data display method of claim 4, wherein the predefined form is a visual display form.

6. The secured data display method of claim 4, wherein the predefined form is an audio form.

7. The secured data display method of claim 1, wherein the step of receiving the output data transmitted by the data access device of the encryption system according to the second communication protocol comprises:
receiving the output data transmitted by the data access device of the encryption system via a second encryption mechanism.

8. The secured data display method of claim 1, wherein the first communication protocol and the second communication protocol are a same communication protocol.

9. The secured data display method of claim 1, wherein the first communication protocol and the second communication protocol are different communication protocols.

10. The secured data display method of claim 1, wherein the first communication protocol and the second communication protocol are contactless communication protocols.

11. The secured data display method of claim 1, wherein the first communication protocol and the second communication protocol are contact-based communication protocols.

12. A secured data storage device capable of non-intrusively and non-destructively displaying data for an encryption system, comprising:
an encryption unit, for receiving and storing a secured data transmitted via a first encryption mechanism according to a first communication protocol; and
an output unit, for receiving an output data transmitted by a data access device of the encryption system according to a second communication protocol;
wherein the secured data and the output data comprise a same content.

13. The secured data storage device of claim 12, wherein the data access device transmits the secured data to the encryption unit via the first encryption mechanism according to the first communication protocol, and then transmits the output data to the output unit according to the second communication protocol.

14. The secured data storage device of claim 12, wherein the data access device reads the secured data stored in the encryption unit via the first encryption mechanism according to the first communication protocol, and then transmits the output data to the output unit according to the second communication protocol.

15. The secured data storage device of claim 12, further comprising an output module, for outputting in a predefined form according to the output data.

16. The secured data storage device of claim 15, wherein the predefined form is a visual display form.

17. The secured data storage device of claim 16, wherein the output module is a liquid crystal display (LCD), a screen or an electronic paper.

18. The secured data storage device of claim 15, wherein the predefined form is an audio form.

19. The secured data storage device of claim 18, wherein the output module is an audio speaker.

20. The secured data storage device of claim 12, wherein the output unit receives the output data transmitted by the data access device via a second encryption mechanism according to the second communication protocol.

21. The secured data storage device of claim 12, wherein the first communication protocol and the second communication protocol are a same communication protocol.

22. The secured data storage device of claim 12, wherein the first communication protocol and the second communication protocol are different communication protocols.

23. The secured data storage device of claim 12, wherein the first communication protocol and the second communication protocol are contactless communication protocols.

24. The secured data storage device of claim 12, wherein the first communication protocol and the second communication protocol are contact-based communication protocols.

25. An encryption chip card capable of non-intrusively and non-destructively displaying secured data in a encryption/decryption environment, comprising:
an encryption chip, for receiving and storing a secured data transmitted via a first encryption mechanism according to a first communication protocol; and
a output chip, for receiving an output data transmitted by a reader according to a second communication protocol;
wherein the secured data and the output data comprise a same content.

26. The encryption chip card of claim 25, wherein the reader, transmits the secured data to the encryption chip via the first encryption mechanism according to the first communication protocol, and then transmits the output data to the output chip according to the second communication protocol.

27. The encryption chip card of claim 25, wherein the reader reads the secured data stored in the encryption chip via the first encryption mechanism according to the first communication protocol, and then transmits the output data to the output chip according to the second communication protocol.

28. The encryption chip card of claim 25, further comprising an output module, for outputting in a predefined form according to the output data.

29. The encryption chip card of claim 28, wherein the predefined form is a visual display form.

30. The encryption chip card of claim 29, wherein the output module is a liquid crystal display (LCD), a screen or an electronic paper.

31. The encryption chip card of claim 28, wherein the predefined form is an audio form.

32. The encryption chip card of claim 31, wherein the output module is an audio speaker.

33. The encryption chip card of claim 25, wherein the output chip receives the output data transmitted by the reader via a second encryption mechanism according to the second communication protocol.

34. The encryption chip card of claim 25, wherein the first communication protocol and the second communication protocol are a same communication protocol.

35. The encryption chip card of claim 25, wherein the first communication protocol and the second communication protocol are different communication protocols.

36. The encryption chip card of claim 25, wherein the first communication protocol and the second communication protocol are contactless communication protocols.

37. The encryption chip card of claim 25, wherein the first communication protocol and the second communication protocol are contact-based communication protocols.
